(19) United States
(12) Patent Application Publication
(10) Pub. No.: US 2011/0272237 A1
(43) Pub. Date: Nov. 10, 2011

(54) CONTROLLABLE ELECTROMECHANICAL CLUTCH (VARIANTS).

(76) Inventor: Martyn Sergeevich Nunuparov, Moscow (RU)

(21) Appl. No.: 13/002,306

(22) PCT Filed: Jun. 29, 2009
(86) PCT No.: PCT/RU2009/000319

§ 371 Date: Apr. 17, 2011

(30) Foreign Application Priority Data
Jul. 2, 2008 (RU) 2008126543

(51) Int. Cl. F16D 28/00

(52) U.S. Cl. 192/84.7

(57) ABSTRACT

Controllable electromechanical clutch primarily for automated devices of various applications like blocking or interlocking mechanisms, electronic locks, robotics, automotive devices, comprising concentrically arranged outer and inner bodies, interacting through the coupling joint with coupling elements associated with one of the bodies which can block rotation of another clutch body, an electrical actuator and a control element associated with this actuator which has two stable positions wherein low energy electrical impulse applied to an actuator can be used to change the position of the mentioned control element, so that the coupling elements change its trajectory and result in engagement or disengagement of the clutch.

### FIELD OF INVENTION

The invention relates to electromechanical devices, electrically controlled torque transmissions and can be used as a standalone coupling devices and for automation systems with various purposes of blocking or locking mechanisms.

Preferential use of the invention is expected in the devices that transmit torque in locking devices such as electronic door or safe locks, or other type of locking or blocking devices, robotics, automotive, etc.

Main feature of the invention is the ability to control the operation of the interlocking devices by the very low power electrical signal.

### PRIOR ART

Torque transmission device (clutch) with electric control are widely used in machinery equipment and devices for a different purposes, and as a rule, are structurally complex and energy-consuming [US20010005998 A1, Jul. 5, 2001; SU1488631 A1, Jun. 23, 1989; U.S. Pat. No. 7,063,194 B2, Jun. 20, 2006]. This fact limits their use in devices of that need low energy management.

Electromechanical clutch [U.S. Pat. No. 6,684,992 B2, Feb. 3, 2004], known from the prior art comprise a concentrically arranged outer and inner clutch bodies, interacting through the coupling joint when engaged, an electrical actuator and a control element associated with mentioned actuator. Electromagnet is used as an actuator in this known clutch.

The disadvantage of this device is a required high power management, so as to enable the clutch and to maintain it in engaged ON-state requires significant energy consumption. High power consumption of this device makes it possible to work only from an external power supply or with the high capacitive battery.

### DISCLOSURE OF THE INVENTION

The development of microelectronics and micromechanics, the use of micromechanical devices power sources based on new principles, such as solar panels, sources based on the piezoelectric effect, necessitates the development of electromechanical actuators with low power consumption at the level of microwatts and limits time of consumption to a fraction of a second.

The aim of the present invention is a significant reduction of electrical consumption, as well as simplifying design and improving performance of controllable electromechanical clutch.

This goal is achieved in such controllable electromechanical clutch that comprise a concentrically arranged outer and inner clutch bodies, interacting through the coupling joint, electrical actuator, control element connected with an actuator, which can be placed into two stable positions, mentioned coupling joint includes stops at the outer clutch body and at least one coupling element of the clutch, hinged on the inside clutch body. The coupling element is disposed in the annular channel of the outer clutch body and has the ability to cinematically interact with the mentioned control element and stops so that in a certain position of control element coupling element changes its trajectory and hits up into stops on the outer clutch body, resulting in blocking the clutch.

Low power consumption of this clutch is achieved by the fact that the reposition of control element from one stable position to another actuated by an actuator at the moments only when it is not loaded by interaction with coupling elements.

Electric micro motor or solenoid can be used as a variant of an actuator that place control element into desired position.

In addition, to reduce the load on the control element when it is connected to electric motor it is designed as a quick-response rotary cam, balanced with respect to the axis of rotation and this cam can be simply loaded by the light spring that is used to fix control element in two mentioned stable positions.

To ensure the compactness of the clutch actuator is placed in the body of the outer clutch body, and its accommodation can be coaxial or orthogonal with the axis of the clutch, depending on the overall requirements of a particular device.

If necessary, the control element may be connected with an actuator by more complex mechanical transmission, like for example, worm, rack and gear, screw, etc.

To let clutch work in both direction it may comprise two spring-loaded coupling elements, hinged with inner clutch body and oppositely arranged with respect to each other.

To enhance the reliability of coupling, the coupling element is made oblong, its front end has a sloping flat area for a tight coupling with a stops on the outer clutch body, allowing a maximum area of locking stop, while reducing damaging of stop surface and the rear portion of coupling element has a projection based on the shoulder of the segmental wall inside the inner clutch body. Wire spring is installed in the groove of the external part of the coupling elements and mentioned segmental wall, combining these elements in the clutch, realizing some like hinge joint.

Most simple stops may be formed in the outer wall of the outer clutch body and the surface of stops beveled outward, so that increases the reliability of operation of the clutch.

To prevent jamming of the control element by the load of interaction with coupling element clutch may have some electronic feedback means containing an electronic micro switch in the actuator control circuit. This switch should be pressed at the moment when control element is free to be shifted from one fixed states to another. It can be made by any mechanical means that detects proper mutual angular positions of clutch bodies, like for example a ball in a cylindrical channel of outer clutch body associated with spring-loaded button of micro switch and an annular groove with a tab on the inside of the inner clutch body. The ball protrudes into annular groove and press the micro switch at the moment when it interacts with the tab. Position of the tab should be chosen at such angle when coupling elements will be are far away from the control element to let them free rotates.

In an another embodiment, a controllable electromechanical clutch comprises concentrically arranged outer and inner clutch body, interacting through the coupling joint, electrical actuator, the control element which is associated with an actuator and can be placed into two stable positions, the coupling joint comprises stops on the inner clutch body that moves in the annual channel of the outer clutch body and at least two coupling elements hosted in the radial groove arranged in the outer clutch body with an exit into mentioned annular channel of the clutch. Mentioned coupling elements can prevent the rotation of inner clutch body leaning on the stops of this body. Movement of control element from one stable position to another is possible only in the absence of its load from the coupling elements of the clutch.

In addition, the coupling elements can be interconnected by wire spring acting on the repulsing of the coupling elements away from the control elements towards annular channel.

Most simply stops can be formed by recesses in the body of the inner clutch body. Electric micro motor can be used as an actuator placed in the outer clutch body coaxial with clutch axis. To reduce the load on the actuator control element is designed as a quick-response rotary cam, symmetrical and balanced about the axis of rotation, with the rotary cam fixed to the shaft of the micro motor.

### BRIEF DESCRIPTION OF DRAWINGS

Features of the invention and its advantages can be seen from the following detailed description, drawn up with regard to the attached drawings, where:

FIG. 1—controllable electromechanical clutch assembly (variant #1);

FIG. 1a—a view on the clutch assembly from the inner body side;

FIG. 1b—a view on the clutch assembly from the outer body side;

FIG. 1c—a view on the parts associated with inner clutch body;

FIG. 1d—a view on the parts associated with outer clutch body;

FIG. 1e—arrangement of the elements in the coupling joint, when clutch is engaged;

FIG. 1g—arrangement of the elements in the coupling joint, when clutch is free;

FIG. 2—controllable electromechanical clutch assembly (variant #2);

FIG. 2a—a view on the parts associated with outer clutch body;

FIG. 2b—a view on the inner clutch body with recessed stops;

FIG. 2c—sectional drawing of the clutch without the inner body;

FIG. 2d—arrangement of the coupling and control elements, when clutch is engaged;

FIG. 2e—arrangement of the coupling elements and control, when clutch is free;

### DETAILED DESCRIPTION

A detailed description of the invention discloses only some of the possible embodiments, but not in any way limiting its scope including the scope of these patent descriptions.

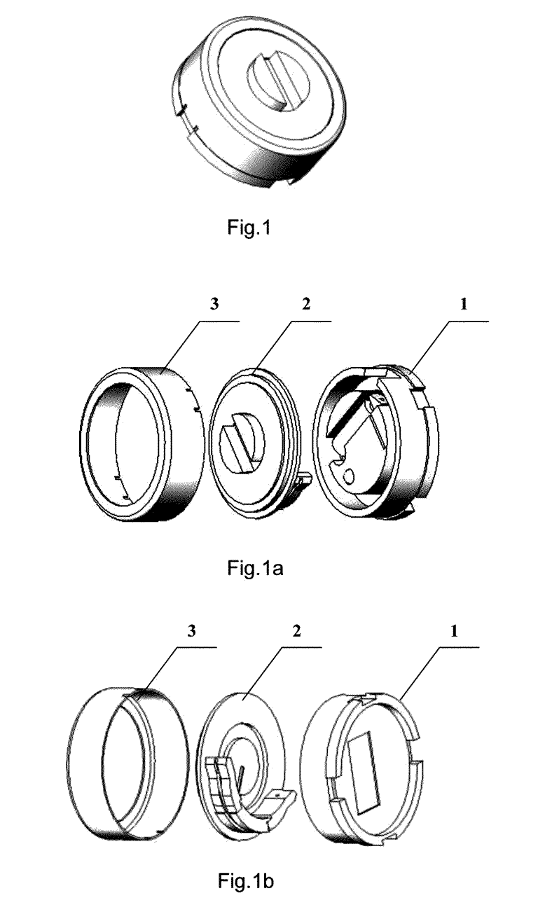

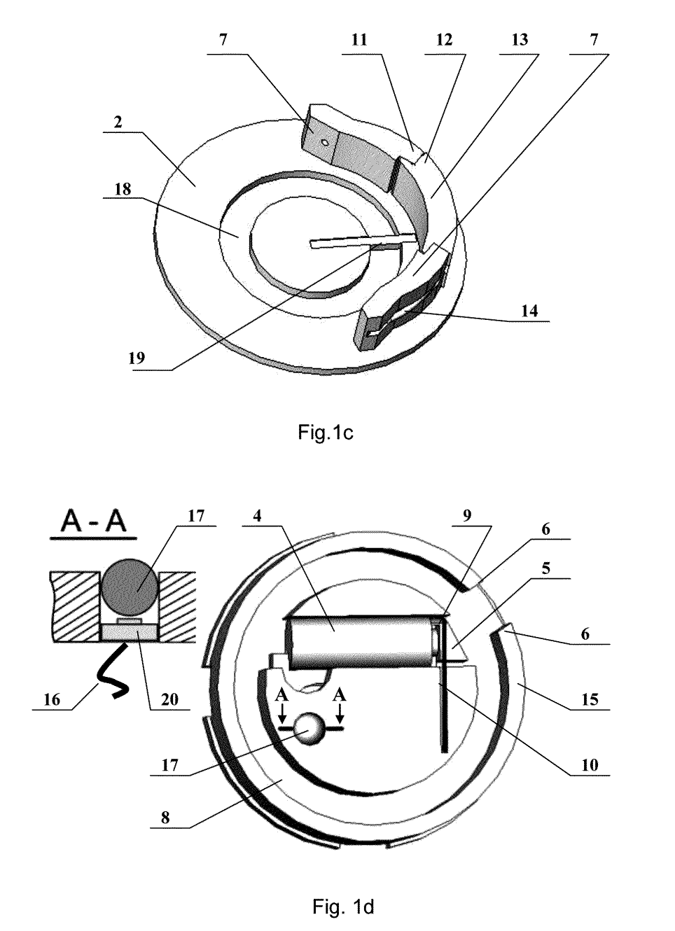

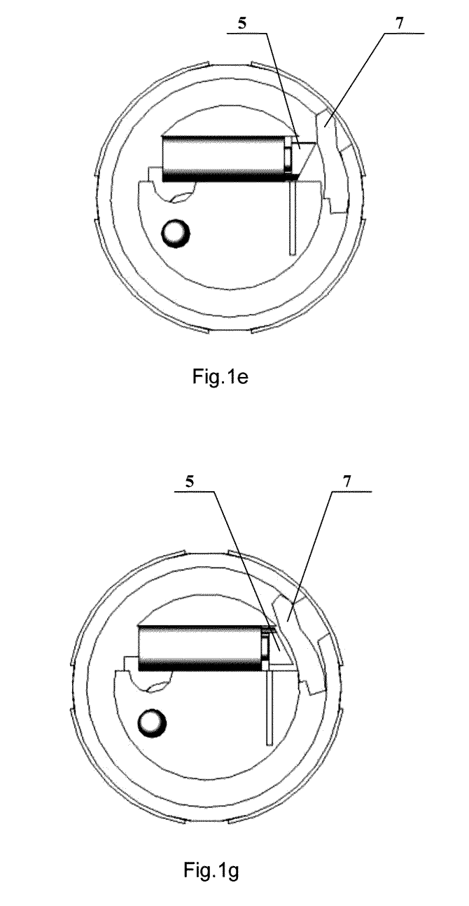

According to the invention, controllable electromechanical clutch (variant #1) includes concentrically arranged outer 1 and inner 2 clutch bodies, and, if necessary, the cover 3 (FIGS. 1a and 1b). Electric micro motor chosen as an actuator 4 in this embodiment. Control element in the form of cam 5 is connected to the shaft of actuator and both are disposed in the groove of outer clutch body (see FIG. 1d). Coupling joints includes stops 6 recessed on the outer clutch body (FIG. 1d) and coupling elements 7 (FIG. 1c), pivotally connected to the projection 13 on the inner clutch body 2. Combined coupling elements 7 of the clutch are disposed in the annular channel 8 when clutch is assembled with the ability to interact with the control element 5.

Cam 5 is designed as a quick-response rotary cam, balanced with respect to the axis of rotation, the cam may have a protrusion 9 for interacting with the wire spring 10, which fixes the cam in the two stable positions corresponding to ON or OFF states of the clutch. When control element 5 is in the ON-position it slightly protrudes into annular channel 8 (FIG. 1e). This protrusion makes coupling element 7 to change its trajectory while it moves in the annular channel 8 resulting in the position of coupling element 7 when it stops at the stop 6 (FIG. 1e). Clutch is engaged. When control element 5 is in the OFF-position it does not protrude into annular channel 8 and coupling element 7 moves in channel 8 without any blocks and clutch rotates free (FIG. 1g).

The profile of coupling elements 7 has a special oblong shape with a thinning in the middle. The front end of coupling elements 7 have a sloping flat area for a tight coupling with a stops 6 on the outer clutch body 1, allowing a maximum area of locking stop, while reducing damaging of the stops (see FIG. 1e). Wire spring 14 is installed in the groove of the coupling elements and projection 13, combining these elements in the clutch and realizing hinge with the projection 13.

Micro switch 20 (FIG. 1d) is used as an electronic feedback means in the control circuit of actuator. A ball 17 is placed in a cylindrical channel under a switch 20 and protrudes into the groove 18 at the inner clutch body when clutch bodies are assembled. When it meets with a protrusion-tab 19 in the groove 18 it presses the micro switch 20. Mutual angular arrangement of protrusion-tab 19 and a ball 17 location is made so as the interaction of the protrusion-tab 19 and ball 17 and thereby triggering of the micro switch 20 occurs at the maximum angular distance of the coupling elements 7 and of the control element 5. At this moment actuator can shift control element 5 between fixed positions without external load or jamming from coupling elements 7.

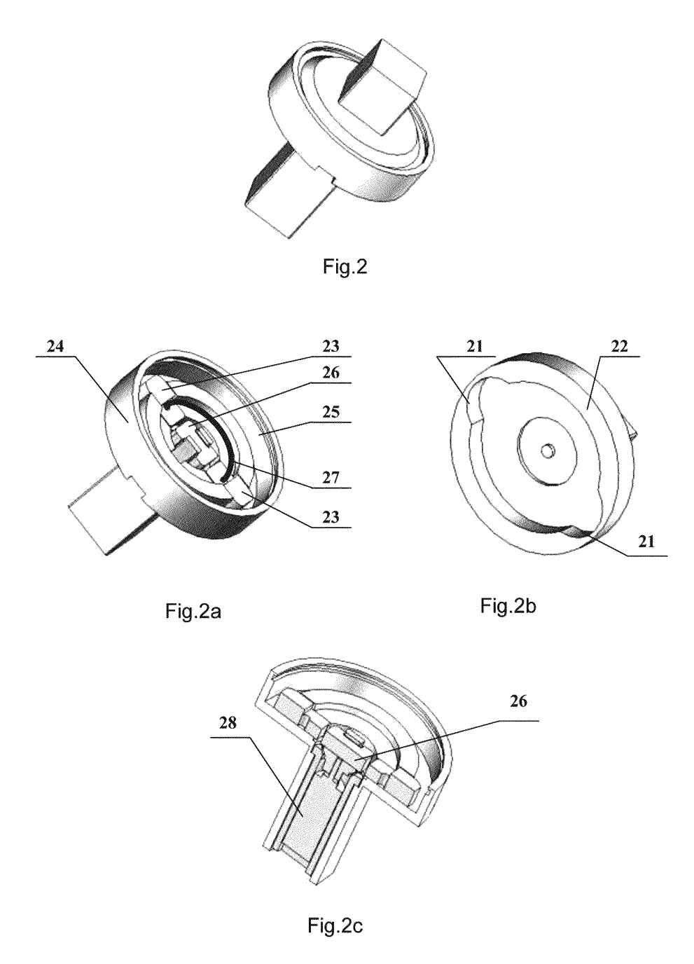

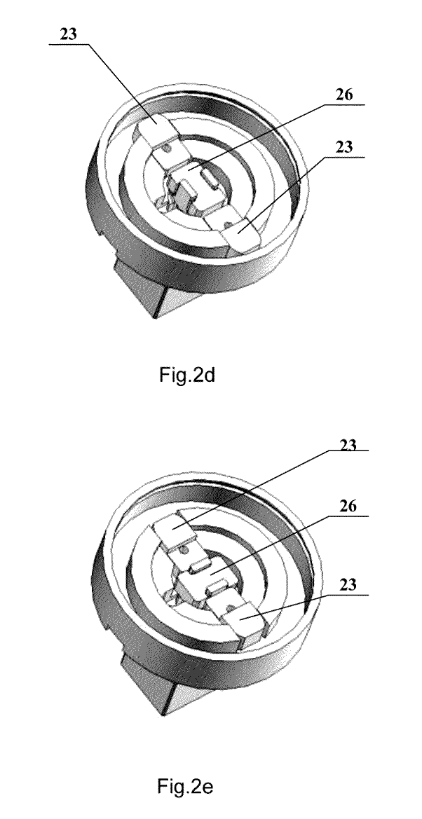

In an another embodiment (FIG. 2) clutch assembly includes inner clutch body 22 with stops 21 formed by the round recesses in this body part and outer clutch body 24 with two movable spring-loaded coupling elements 23, placed in the radial groove of outer clutch body 24. Micro motor 28 with the control element 26 connected to the shaft of micro motor are placed in the outer clutch body coaxial with clutch axis. Coupling elements 23 are combined with the spring 27 that forces coupling elements 23 to protrude into the annular channel 25 out from the control element 26. When coupling elements 23 protrude in the annular channel 25 it can block the rotation of inner clutch body leaning on the stops 21. On the other hand when coupling elements 23 interact with the stops 21 it are forced to by these round stops to move towards the center of the clutch. To retain coupling elements 23 in the annular channel 25 control element 26 is placed by the actuator 28 in the position when its long side is arranged along the radial groove (FIG. 2d). When actuator moves control elements 26 in the second fixed position—long side perpendicular to radial groove, coupling elements 23 are allowed to move out from the annular channel 25. It doesn't block the rotation of inner clutch body—and clutch becomes free to rotate.

Control element 26 is designed as a quick-response rotary cam, symmetrical and balanced about the axis of rotation.

This embodiment assumes that both clutch bodies have the initial mutual angular position, where coupling elements 23 are our from the control element 26, inside the round stops let control element to free rotate from one fixed position to another. Electronic feedback means similar to what has been discussed in clutch (variant #1) or different can be arranged in clutch (variant #2) to control this initial arrangement of clutch bodies.

Proposed above embodiment of clutches works as follows:

Clutch by variants #1 can be free rotated (not engaged) when control element (cam) 5 is held in a position where it does not prevent the free movement of the coupling elements 7 in the annular channel 8 (FIG. 1g). When the cam 5 placed in the other stable position, in which it protrudes into the annular channel 8, then coupling element 7 under the action of external moment from inner clutch body overcomes the resistance of spring 14 and by changing the trajectory of movement, engages with a stop 6 (FIG. 1e). In results movement of coupling element 7 and associated with it movement of inner clutch body is terminated (clutch is engaged).

As it was mentioned movement of control element 5 from one stable position to another is possible in the absence of its connection with the coupling elements 7 of the clutch.

To secure the moment when electronics execute cam 5 rotation by the actuator (protection against jamming of control element 5), coupling elements 7 should be far out from the cam 5. This moment is provided by feedback electronic circuit based on switch 20 with ball 17 at the outer clutch body and the tab 19 on the inner clutch body. Only at the moment when ball 17 meets tab 19 micro switch 20 provide signal to an actuator to move the cam 5.

Clutch by variants #2 can be free rotated (not engaged) when control element (cam) 26 is held in a position where it does not prevent the free movement of the coupling elements 23 in the radial channel (FIG. 2e). So that coupling elements 23 can be moved out from the annular channel 26 allowing inner clutch body free rotates. When the clutch actuator 28 rotates a control element 26 in the position in which the convergence of the coupling elements becomes impossible (FIG. 2a, c, d), then an external torque applied to inner clutch body is transferred to the outer clutch body by the interaction of coupling elements 23 with stops 21 on the inner clutch body—clutch is engaged.

The proposed variants of clutch have a simple and compact design and what is most important are able to be actuated by an electrical pulse of a very low power applied to actuator.

Prototypes of both variants of controllable clutches have been developed.

Experimental verification confirmed the high efficiency of proposed technical solutions, since the energy for the ON/OFF triggering of the clutch does not exceed 1.5 millijoules. Proposed clutches can be widely used in the designs of electronic locks and robotic systems with long life of autonomous power supply.

In addition, various aspects, concepts and features of the invention can be described and shown as an options for its implementation or a combination of examples of the different variants of the invention can also be used in an alternative embodiments, individually or in the form of various combinations of the above examples. However, all such combinations and sub combination included in the boundaries of the present invention.

1. Controllable electromechanical clutch primarily for automated devices of various applications, comprising concentrically arranged outer and inner bodies, interacting through the coupling joint with coupling elements pivotally associated with the inner body, an electrical actuator and a control element moved by this actuator which can be positioned into two fixed positions, where coupling elements is introduced in the annular channel with at least one stop arranged at the outer clutch body and where the triggering of control element into one of the fixed position can change the trajectory of coupling elements initiating its catch at the mentioned stops on outer clutch body so that results in clutch engagement and where changes of one of fixed position of a control element to another are initiated in the absence of its load from the coupling elements.

2. The device according of claim 1, wherein the control element is designed as a quick-response rotary cam, balanced with respect to the axis of rotation, the cam is associated with the spring that fix it in two stable positions.

3. The device according to claim 1, wherein the actuator is placed in the body of the outer clutch body coaxial with clutch axis.

4. The device according to claim 1, wherein the actuator is placed in the body of the outer clutch body orthogonal to clutch axis.

5. The device according to claim 1, wherein electric micro motor is used as an actuator.

6. The device according to claim 1, wherein electric solenoid is used as an actuator.

7. The device according to claim 1, 5 wherein the control element attached to the shaft of the micro motor.

8. The device according to claim 1, wherein the control element is associated with the actuator by mechanical transmission.

9. The device according to claim 1, 6, wherein the control element is connected with the shaft of solenoid through the levers.

10. The device according to claim 1, wherein the clutch assembly has two coupling elements oppositely arranged with respect to each other hinged and combined by the wire spring with the projection on the inner clutch body.

11. The device according to claim 1, 10, wherein the coupling elements are made oblong, its front end have a sloping flat area for a tight coupling with a stops on the outer clutch body.

12. The device according to claim 1, wherein the stops are formed by cut in the outer wall of the outer clutch body.

13. The device according to claim 12, wherein the surface of the stops beveled out.

14. The device according to claim 1, which in addition has a feedback electronic means, containing an electronic micro switch at the any clutch body and mechanical means to push this micro switch.

15. The device according to claim 14, wherein the feedback electronic means is used to control the angular mutual position of the inner and the outer clutch body.

16. Controllable electromechanical clutch comprising concentrically arranged outer and inner clutch bodies, interacting through the coupling joint, with coupling elements located in the radial groove of an outer clutch body and with ability to interact with the stops cutted at the inner clutch body, an electrical actuator and a control element associated with an actuator, wherein the control element is arranged with the possibility to be placed it in two stable positions along or orthogonal to mentioned radial groove and when control element is placed in first mentioned positions it restricts the movement of the coupling elements so that clutch engages and when control element is placed in the second mentioned position then coupling elements are free to move and cannot translate torque between clutch bodies and wherein movement of control element from one stable position to another is possible in the absence of its load from the coupling elements of the clutch.

17. The device according to claim 16, wherein the coupling elements are combined by the spring which repulse it from each other.

18. The device according to claim 16, wherein the stops are formed by recesses in the inner clutch body.

19. The device according to claim 16, wherein electric micro motor is used as an actuator and placed in the body of the outer clutch body coaxial with clutch axis.

20. The device according to claim 16, which in addition has a feedback electronic means, containing an electronic micro switch that is used to control the mutual angular position of the inner and the outer clutch bodies.

21. The device according to claim 16, 19 wherein the control element is designed as a quick-response rotary cam, balanced about the axis of its rotation and fixed on the shaft of the micro motor.
